(19) United States
(12) Patent Application Publication
(10) Pub. No.: US 2004/0128747 A1
(43) Pub. Date: Jul. 8, 2004

(54) Personal hydration and cooling system

(76) Inventors: Scott Bumbarger, Decatur, AL (US); Willard W. Case, Madison, AL (US); Nancy Keen, Huntsville, AL (US); Steven Tanner, Madison, AL (US)

Correspondence Address: Richard S. Myers, Jr., Stites & Harbison PLLC, Suite 1800, 424 Church Street, Nashville, TN, 37219-2376, US

(21) Appl. No.: 10/729,850

(22) Filed: Dec. 3, 2003

Related U.S. Application Data
(60) Provisional application No. 60/430,889, filed on Dec. 3, 2002.

(51) Int. Cl. A62B 17/00; A62D 5/00

(52) U.S. Cl. 2/458

(57) ABSTRACT

A method of cooling a person by evaporation, comprising providing a liquid-retaining composite material, and a bladder that stores a liquid; hydrating said multi-layered composite with a liquid; and employing said multi-layered, liquid-retaining composite material as a garment or a flat sheet and evaporatively cooling said person.

### PRIORITY

This application claims priority under 35 U.S.C. § 119(e) to U.S. Patent Application No. 60/430,889, filed on Dec. 3, 2002, the contents of which are incorporated herein by reference.

### FIELD OF THE INVENTION

The present invention relates to the field of evaporative cooling garments.

### BACKGROUND OF THE INVENTION

Many inventions appear in the prior art that relate to composites and/or garments for the comfort and/or protection of a person's body. These inventions relate to heating or cooling of a person's body; keeping the body wet or dry; protection of the body from conditions of extreme heat or cold, as well as protection of the body from impact from high speed objects. The use of liquid absorbent composites has been utilized in many ways to aid in the effectiveness of such composites and garments. Examples of U.S. patents relating in one way or another to this art are as follows: U.S. Pat. Nos. 2,855,758; 3,429,138; 3,670,731; 3,971,373; 4,105,033; 4,133,055; 4,235,227; 4,429,001; 4,556,055; 5,113,666; 5,289,695; 5,328,759; 5,419,955; and 5,480,410; each of which are incorporated herein by reference.

U.S. Pat. No. 5,885,912, incorporated herein by reference, discloses several types of evaporative cooling garments constructed in accordance with the embodiments of composite materials disclosed therein, and suitable for use with respect to the present invention.

U.S. Pat. No. 6,371,977, incorporated herein by reference, discloses composite material suitable for use with the present invention that comprises a hydrophilic polymeric fiber and/or hydrophilic polymeric particles in combination with batting or fiberfill material. The material is activated by being hydrated.

As discussed below, a bladder is incorporated into the personal hydration system of the present invention. Several bladders are adaptable for this purpose. For example, see U.S. Pat. Nos. 5,941,640; 6,364,168; 6,212,959; 6,070,767; 6,032,831; D411,915; 5,894,955 and 5,864,880; all of which are incorporated herein by reference.

U.S. Pat. No. 5,864,880 discloses a jersey that comprises an enclosure for the removable insertion of a liquid-filled bladder. The bladder and enclosure of '880 may be incorporated into the cooling garment of the present invention in the same manner as its incorporation into this jersey.

None of the prior art examples listed above disclose or suggest an evaporative cooling system that incorporates a bladder to provide a means for maintaining an activated garment and possibly a source for drinking water for a wearer or user.

### OBJECTS AND SUMMARY OF THE INVENTION

In view of the above, what is needed is an evaporative cooling garment that has the capability of remaining activated for an extended period of time. Further, what is needed is an evaporative cooling garment that also provides a source for drinking water for a wearer or user.

As stated above, the present invention generally relates to evaporative cooling garments. More specifically, the present invention relates to fluid retaining materials, and, in certain embodiments, to a polymeric blend and a multi-layered composite material comprising the fibrous blend suitable for fabrication of a wide variety of items such as protective garments, etc. The composite, after being activated or hydrated by a liquid, provides covering which protects and/or provides comfort. The present invention particularly protects from heat environments. Further, the present invention comprises a bladder or fluid reservoir that allows a wearer to rehydrate or continuously hydrate the composite. Optionally, the bladder may be used to supply a drinking liquid to a wearer of the garment of the present invention. The garments of the present invention include vests, blankets, hats, headbands, neck wraps, shirts, pants, etc.

Accordingly, it is an object of the present invention to provide an evaporative cooling garment or cooling garment system that has the ability to remain in an active or hydrated state for extended periods of time.

It is a another object of the present invention to provide an evaporative cooling garment or cooling garment system that alloys a user or wearer to consume water or another liquid.

One embodiment of the present invention is a method of cooling a person by evaporation that comprises providing a multi-layered, liquid-retaining composite material comprising at least one of hydrophilic polymeric fibers or hydrophilic polymeric particles that that absorb at least about 2.5 times the fiber's or particle's weight in water; providing a bladder that stores a liquid; hydrating said multi-layered composite with a liquid; and employing said multi-layered, liquid-retaining composite material as a garment or a flat sheet and evaporatively cooling said person; wherein the bladder houses a liquid used to maintain or provide a state of hydration for at least part of the composite. Of course, the present invention may be used to cool mammals and other animals as well. One example of a mammal that benefits from the present invention is a horse.

Another embodiment of the present invention is a liquid-retaining, evaporative cooling device that comprises a multi-layered, liquid-retaining composite material. This material comprises at least one of hydrophilic polymeric fibers or hydrophilic polymeric particles that that absorb at least about 2.5 times the fiber's or particle's weight in water; wherein said device comprises a bladder to hold a liquid and maintain or provide a state of hydration for at least part of the composite material.

Another embodiment of the present invention is a multi-layered evaporative cooling device that comprises a retainer layer, a filler layer that comprises superabsorbent polymeric fibers, and a conductive layer, wherein the retainer and conductive layers communicate with the filler layer. The device of this embodiment further comprises a bladder for holding liquid, with the bladder communicating with and hydrating the filler layer.

### BRIEF DESCRIPTION OF THE DRAWINGS

The following drawings include depictions of preferred examples of the present invention. These drawings/examples are given for illustration of embodiments of the present invention, and are not intended to be limiting thereof.

FIG. 1 is a diagram showing the basic configuration and operation of a cooling garment of the present invention.

FIG. 2 shows an exploded view of an example of the fabric that comprises an embodiment of a cooling garment of the present invention. With respect to this figure, the absorbent material may be a fiber/particle combination, fibers, or particles.

FIG. 3 shows an embodiment of the cooling device of the present invention. In this embodiment, the bladder is attached to a vest via a harness system, and the bladder comprises a liquid delivery tube that provides liquid to the cooling device with the wearer having the option to drink the liquid in the bladder.

FIG. 4 shows the embodiment of FIG. 3, with a additional liquid delivery tube to separately hydrate the cooling device.

FIG. 5 show an embodiment where the bladder is attached directly to the cooling garment through an input valve that delivers liquid from the bladder to the absorbent material in the garment.

### DESCRIPTION OF THE INVENTION

This invention provides a garment that comprises hydrophilic polymeric particles, fibers, or blends thereof. Optionally, the garment further comprises a fiberfill material. Additionally, in other embodiments, the present invention provides garments that are produced from a multi-layered, liquid retaining composite material having on one side a conductive layer that allows free passage of gasses therethrough. In other embodiments, a filler layer having superabsorbant properties is disposed adjacent this conductive layer, with a retainer layer contacting the filler layer opposite the conductive layer.

Particularly, the material is hydrated, and a user (a person or animal) is cooled by the evaporation of the hydrate.

These and other garments of the present invention comprise a bladder (i.e., reservoir, or other type container to hold a water or liquid supply), which can be adapted to supply the garment with hydrate.

As examples, garments made from the multi-layered composite are extremely effective for use by firemen, law enforcement officers, military personnel and persons such as foundry or bakery workers who are exposed for long periods of time to high temperatures.

In general terms, embodiments of the invention includes a basic configuration of a multi-layered, liquid-retaining composite material comprising of:

a conductive layer which is adapted for placement in close proximity to, or indirect contact with the body of the wearer;

a filler layer impregnated a fiberfill batting-type material and with liquid absorbent particles, fibers, or a combination of both;

a retainer layer for retention of the filler layer between the conductive layer and the retention layer; and, if needed,

an outside protective layer attached to, or placed adjacent to, the outermost surface of the retention layer.

Examples of the cooling material used in the present invention include those disclosed in U.S. Pat. Nos. 6,371,977; 5,855,912; 6,464,672; 6,473,910; and Patent Applications 20020073481 and 20020069448; all of which are incorporated herein by reference.

Embodiments of the Evaporative Cooling Material (Filler Layer)

With respect to the cooling material, and in particular the liquid absorbent material, the blend is a combination of a superabsorbant polymeric fibers, particles, or combinations of both, and fiberfill or batting. The particular fiberfill is not known to be critical, and in some embodiments is not required. That is, any commercial fiberfill may be used as long as it does not adversely affect the performance of the end composite. Thus, the fiberfill, batting, etc. is used to support and disperse the superabsorbent polymeric material (fibers/particles). The fiberfill may be natural fibers, synthetic fibers, woven, nonwoven, etc.

The nature of the fiberfill may vary according to the desired end use. As an example, when the end composite is to be used as or part of a fire retardant garment, the fiberfill or batting is chosen accordingly. In such a case, the fiberfill is typically comprised of a flame and heat resistant material such as woven aramid and/or polybenzamidazole (“PBI”) fibers. That is, the fiberfill may be selected from a group consisting of an aramid polymer fabric material, as blend of aramid polymer fabric materials, a polybenzamidazole material, and a blend of aramid polymer fabric and polybenzamidazole materials. For other non-flame retardant applications, commercial fiberfill such as DuPont DACRON®, available from DuPont, or polyester fiberfill products from Consolidated Textiles, Inc. of Charlotte, N.C. Additionally, U.S. Pat. Nos. 5,104,725; 4,304,817; and 4,818,599; all of which hare incorporated by reference, disclose fiberfill fibers and blends suitable for certain applications of the present invention.

Regarding the hydrophilic fibers discussed above, it is preferable that the hydrophilic fibers absorb at least approximately 2.5 to 3 times their weight in water. As discussed below, a preferred fiber is a polyacrylonitrile/polyacrylate hydrophilic fiber similar to a LANSEAL-F-type material. The hydrophilic fiber of the present invention may also be one of the superabsorbent fibers disclosed in U.S. Pat. No. 5,350,370, incorporated herein by reference. Typically these fibers will have diameters ranging from about 10 to 50 microns and lengths ranging from about 3 to 60 millimeters. Their absorbency will typically range between about 10 and about 40 grams per gram of superabsorbent under a load of 0.5 pounds per square inch (3500 pascals) using 0.9% by weight saline solution. Commercially available superabsorbent fibers include Allied Colloids/Courtalds FSA® 101 and 111; ARCO FIBERSORB® from Arco Corporation of Philadelphia, Pa.; and TOYO BOSEKI KK Lanseal from Toyo Boseki KK of Osaka, Japan.

The use of the term superabsorbent fiber includes fibers that incorporate, embed, or are attached to superabsorbent particles.

In another preferred embodiment, the fibers of the present invention are a bi-component fibers of the sheath-core type with the outer layer being made of cross-linked acrylate copolymer, partially neutralized to the ammonium salt and the inner layer being made of polyacrylonitrile. Such fibers are disclosed in U.S. Pat. No. 4,562,114 incorporated herein by reference.

The fibers of the preferred embodiment of the present invention are thus water-absorbing acrylic fibers which have a stable water-absorbing ability that will not be readily lowered by heat treatment, etc. and which are excellent in physical properties such as strength and elongation and in practical properties such as color fastness, spinnability, etc.

In embodiments that use a fiberfill material, the hydrophilic polymeric fiber may be blended with the fiberfill in a range of from about 15% to 75% with the fiberfill. The blend may be varied depending on the end use of the composite. For instance, a low amount of fiber would result in a light composite that may be used for, for example, a shirt. A high amount of fiber would result in a heavy composite that may be used for, for example, a fireman's suit. Furthermore, the batting can be thickened depending on the use of the end product. For example, a batting with a thickness of 1/16 of an inch (before quilting) may be used as a shirt. A batting with a thickness of over an inch (before quilting), for example, may be used in conjunction with a bulletproof vest.

One of the advantages of the combination of the hydrophilic polymers and the fiberfill material is that the blend both promotes evaporation qualities and provides a means to hold cool or hold hot. That is, the blend retains coolness or warmth when chilled or heated. Hydrophilic blends of the present invention allow certain composites to be microwaved or refrigerated. In such a use, the batting helps act as an insulator to help maintain the desired temperature.

In other embodiments, the cooling material may be the absorbent layer of U.S. 2002/0073481, incorporated herein by reference. That is, the cooling material may comprise one or more layers capable of absorbing liquids such as, for example, water. This embodiment comprises a combination or mixture of thermoplastic fibers and an absorbent material structured such that the absorbent material is substantially held in place. The cooling material of the present invention can comprise coform materials although other suitable absorbent fabrics comprising a combination of thermoplastic fibers and absorbent material may likewise be used in accord with the present invention. Exemplary coform materials are disclosed in U.S. Pat. No. 5,284,703 to Everhart et al. U.S. Pat. No. 5,350,624 to Georger et al. and U.S. Pat. No. 4,100,324 to Anderson et al.; the contents of which are incorporated herein by reference. The term “coform material” generally refers to composite materials comprising a mixture or stabilized matrix of thermoplastic fibers and a second non-thermoplastic material. As an example, coform materials may be made by a process in which at least one meltblown die head is arranged near a chute through which other materials are added to the web while it is forming. Such other materials may include, but are not limited to, fibrous organic materials such as woody or non-woody pulp such as cotton, rayon, recycled paper, pulp fluff and also superabsorbent particles, inorganic absorbent materials, treated polymeric staple fibers and so forth.

This embodiment desirably has a specific capacity of at least about 5 g/g and still more desirably a specific absorbent capacity of at least about 8 g/g. In an exemplary embodiment the absorbent core comprises at least about 100 g/m² coform material, and even more desirably comprises from about 200 g/m² to about 500 g/m² coform material. Further, the material of this embodiment may comprise from about 5% to about 45% thermoplastic polymer fibers and still more desirably comprises from about 10% to about 35% by weight thermoplastic polymer fibers. As one example, the coform material can comprise polypropylene meltblown fibers and wood pulp fibers. As a further example, the absorbent material may be held in a web of thermoplastic staple fibers such as, for example, air-laid or bonded-carded webs. The absorbent core may comprise one or more layers and additional materials, e.g. absorbent materials or particles, may be dispersed within or between the one or more layers to increase the absorbency as desired. As an example U.S. Pat. No. 4,784,892 to Storey et al. teaches an absorbent material of meltblown fibers with an absorbent fibrous material (e.g. wood pulp) as well as superabsorbent dispersed therein; the entire contents of the aforesaid application is incorporated herein by reference. When the superabsorbent is present in the absorption layer, it is generally present in an amount between about 0.5 to about 40% by weight, more generally in and amount about 1% to about 20% by weight of the absorbent layer.

Embodiments of Conductive, Retainer and Protective Layers

Examples of the conductive and retainer layer material are NOMEX™-type fabrics.

A further example of the conductive layer of the present invention may be the “barrier layer” of 2002/0073481. That is, the conductive layer of this embodiment may have a basis weight of at least about 12 g/m² and comprising thermoplastic polymer microfibers having an average fiber denier below about 0.25 and wherein the first layer is positioned between opposed second and third layers having a basis weight of at least about 12 g/m² each and comprising substantially oriented fibers having an average fiber denier of about 2 or more. As a particular example, the inner barrier layer can comprise an SMS fabric having opposed spunbond layers with a basis weight between about 14 g/m² and 34 g/m² and an intermediate meltblown fiber layer having a basis weight between about 12 g/m² and about g/m². In an alternate embodiment, the barrier layer may comprise a microporous film and/or a film/nonwoven laminate. One particularly useful barrier material comprises a breathable stretched filled microporous film. Such films are typically filled with particles and then crushed and/or stretched to form a fine pore network throughout the film. The film-pore network allows gas and water vapor to pass through the film while acting as a barrier to liquids and particulate matter. The amount of filler within the film and the degree of stretching are controlled so as to create a network of micro-pores of a size and/or frequency to impart the desired level of breathability to the fabric. Suitable microporous film and film laminates are disclosed in U.S. Pat. No. 4,777,073 to Sheth, U.S. Pat. No. 5,695,868 to McCormack, U.S. Pat. No. 6,075,179 to McCormack et al., and U.S. Pat. No. 6,037,281 to Mathis et al.; the entire content of each of the aforesaid references are incorporated herein by reference. The films desirably include one or more tackifiers and/or thin bonding layers in order to allow and/or improve thermal bonding of the laminate to the absorbent core or other intermediate layers.

In another specific embodiment, the retainer layer may be the “reinforcing layer” of 2002/0073481. That is, the retainer layer of the present invention may comprise a polymeric fabric that is sufficiently porous so as to allow the transfer of liquids there through and into the absorbent layer. Additionally, the outer layer also needs to be sufficiently durable and strong to withstand the rigors associated with wear and use of the garment. In this regard, desirably the outer layer has a Grab Tensile of at least about 2 kg and still more desirably has a Grab Tensile of at least about 5 kg. The outer reinforcing layer desirably comprises a material having a basis weight between about 12 g/m² and 50 g/m.sup² and still more desirably a material having a basis weight between about 17 g/m² and about 34 g/m². In addition, the outer reinforcing fabric desirably has a hydrohead value of less than about 25 mbar and still more desirably a hydrohead value of between 0 and about 15 mbar. Desirably, the outer reinforcing layer comprises a bonded web of thermoplastic polymer fibers. An exemplary material comprises spunbond fiber webs such as, for example, those described in U.S. Pat. No. 3,802,817 to Matsuki et al., U.S. Pat. No. 5,382,400 to Pike et al., U.S. Pat. No. 5,874,460 to Keck, U.S. Pat. No. 5,460,884 to Kobylivker et al., U.S. Pat. No. 5,336,552 to Strack et al. and U.S. Pat. No. 5,858,515 to Stokes et al., the entire contents of each of the aforesaid references are incorporated herein by reference. In a further aspect, in order to provide improved coverage or opacity to the outer reinforcing layer, the outer reinforcing layer can itself comprise a laminate material such as for example a low basis weight spunbond/meltblown (SM) or spunbond/meltblown/spunbond (SMS) laminate. Exemplary SM and SMS laminates are described in U.S. Pat. No. 4,041,203 to Brock et al. and U.S. Pat. No. 5,607,798 to Kobylivker et al. In addition the outer reinforcing layer may be a nonwoven web laminate of thermoplastic polymer fibers having a denier below 0.5 and a nonwoven web of thermoplastic polymer fibers having a denier greater than 0.5. However, due to the need to have adequate liquid penetration the reinforcing layer can optionally be made hydrophilic such as by treatment with internal or topical wetting agents, use of hydrophilic polymers and so forth.

As discussed herein, various types of protective layers may be incorporated onto or attached to the retainer layer.

Furthermore, the retainer layer may comprise a water proof coating.

The multiple layers can be attached to one another by one or more methods known in the art. Desirably, the layers are bonded in a manner so as to hold the absorbent layer in a substantially fixed position between the inner barrier layer and outer reinforcing layer. As an example, each of the respective layers can be bonded together to form an integrated laminate through the use of adhesives. Additionally, quilting of the material may be desirable and help retard the pooling of the cooling liquid and filler material at the bottom of the garment.

Furthermore, adhesives, such as latexes or hot melts, can be applied to the sheets by gravure rolls, spray equipment and so forth. Still further, the multiple layers can be thermally and/or ultrasonically laminated together to form an integrated laminate. Exemplary ultrasonic bonding processes are described in U.S. Pat. Nos. 4,100,324 and 4,605,454. Generally, ultrasonic bonding involves passing the fabric to be bonded between an anvil and a sonic horn. The layers to be bonded may be passed through an ultrasonic embossing station which, in one aspect, can comprise an ultrasonic calendering head vibrating against a patterned anvil roll. The embossing conditions (e.g., pressure, speed, power input) as well as the embossing pattern may be appropriately selected to provide the desired characteristics in the final product. In a further aspect, one or more webs may be thermally pattern-bonded and which typically involves passing the web or webs to be bonded between a pair of heated bonding rolls. One of the bonding rolls is often patterned in some way so that the fabric is not bonded across its entire surface and the second or anvil roll is either a patterned or smooth roll.

In a further aspect, the edges or periphery of the garment may be sealed to prevent any loss of liquid therethrough. Of course, the composite can be used to form a garment by itself or together with additional materials and/or fabrics.

As stated above, one material suitable for use in the conductive layer is a NOMEX-type material (NOMEX being available from the DuPont Corporation). One example of a coating material may be a BREATHE TEX-type material which provides a breathable but waterproof covering that is an excellent thermal conductor and presents a cool dry surface to the body of the wearer. BREATHE-TEX itself is available from Alden Industries Inc.

One example of a batting material suitable for the filler layer is an ARAMID-E 89-type material, with the material itself being available from DuPont.

One material suitable for particles impregnated within the filler material is a cross-linked polyacrylamide polymer available from Plant Health Care Inc. As stated, another material may be a LANSEAL-F-type material, a fibrous hydrophilic polymer that may be blended with other fiberfill or batting materials and fibers.

One material suitable for use in a retainer layer is a high grade of cotton. If fire protection without a discrete protective layer is desired, cotton-fire resistant (cotton-FR) may be used. This is a cotton fabric that has been sprayed with a fire retardant.

One material suitable for use in as a fire protective layer is a NOMEX-type material, which, as stated above, is available from the DuPont corporation.

One material suitable for use in an impact protective layer such as would be utilized by persons subjected to gunfire is a CORDURA-type material and a KEVLAR-type material, both of which being available from DuPont.

For example, to use a garment made from the basic multi-layered composite by a fireman, the retainer layer may simply be sprayed with a fire retardant coating. If required, an additional discrete layer of fire retardant material may be easily added.

Thus, after soaking a garment as described above, the multi-layered composite provides an extremely effective protection to the wearer not only against extreme heat but also against injury from falling debris as may be encountered by firemen within a burning building.

In use, any item fabricated from the composite material of the various embodiments of the present invention is soaked in a liquid, such as water, for a predetermined time. A typical soaking period may be about 2 to 5 minutes.

In a soaked (or activated) condition, a garment fabricated from a multi-layered composite as described provides an extremely effective body protection against intense heat. This protection is provided in multiple ways. First, the retainer layer of the composite may be provided with a heat resistant coating, the function of which is obvious by definition. Second, the liquid (typically water) contained by the hydrated particles and/or fibers or combinations thereof within the filler layer provide an effective thermal insulator between the retainer layer and the thermally conductive layer adjacent a person's body. Third, as the retainer layer is exposed to heat the liquid within the filler layer begins to vaporize and pass slowly through the retainer layer, thus creating a moist film on the outer surface of tie retainer layer. The moisture itself resists the heat and protects the outer surface of the retainer layer. Fourth, as the moisture on the retainer layer evaporates, an evaporative cooling occurs which further cools the retainer layer. (It will be readily understood that liquid stored within the filler layer will provide a continuation of these cooling processes). Fifth, if the user is perspiring, the perspiration will, to a large extent, evaporate and cool the user. The moisture is then carried in the form of humid air through the breathable conductive layer and into the filler layer for absorption by the partially saturated absorbent particles or fibers. To facilitate this effect, it will be noted that in certain applications the particles are not totally saturated during the soaking process, and that the conductive layer is by design an effective thermal conductor. The conductive layer is also preferably waterproof, yet porous enough to be breathable.

As stated above, with respect to an application requiring protection from Intense heat, a saturation of 50% to 90% may be appropriate so as to provide a means of absorbing the perspiration of the user. If the user is perspiring the perspiration will to a large extent evaporate thus cooling the user. The moisture will then be carried in the form of humid air through the breathable conductive layer and into the filler layer for absorption by the partially saturated particles. Other cooling functions of the composite are also described hereinabove.

Bladder

As stated above, a bladder or water reservoir is incorporated into the personal hydration and cooling system of the present invention. The bladder may be similar in structure and function to one disclosed in the patents incorporated by reference above, or may be one that is commercially available in the hands-free hydration field. For example, the bladder may be one that is available from CAMELBAK (Petaluma, Calif.), HYDRAPAK (Berkeley, Calif.) or Ultimate Direction, Inc., Emeryville Calif. Examples of hydration systems and mouthpieces therefore are disclosed in U.S. Pat. Nos. 5,727,714, 5,060,833, 5,085,349, and 6,070,767, the disclosures of which are hereby incorporated by reference.

In one example, the bladder is a typical flexible, non-porous, bag-like reservoir that contains liquid. It varies in size and shape depending on how it is incorporated into the cooling composite. It typically includes an input port such as a sealable filler spout and at least one exit port. The exit port may direct liquid into the filler layer, or into a flexible hose or tube that can be inserteable into a filler layer input port and/or a user's mouth for drinking.

The bladder may be removably attached to the cooling garment such as by, for example, a hook and loop connection. Further the bladder may be completely detached from the garment, with the exception of a device or connection tube-type that provides liquid flow into the garment. This device may be as simple as a supply tube similar to one disclosed in connection with the patents listed above. As stated above, the bladder may be placed in a “pocket”, “bladder compartment”, or “pouch” that is incorporated into the garment.

Specifically, the bladder may be incorporated into the garment in the same manner as the systems of U.S. Pat. Nos. 5,427,290; 6,241,135; 5,727,720; D418,299; 5,975,387 or 5,941,640, all of which are incorporated herein by reference, with a connection (preferably a tube) that allows liquid flow into the garment.

Additionally, a shoulder harness, backpack-type system may be used to hold the bladder, including the system disclosed in U.S. Pat. No. 5,864,880, incorporated herein by reference. In one such system, the bladder is removable from the backpack-type harness system, allowing the bladder to be removed or refilled with having to remove the harness. The harness or straps to accommodate this system may be incorporated into a garment of the present invention.

Various valves, tubes, or pumps as known in the art, in addition to the ones disclosed in the bladder-related patents incorporated above may be used in connection with the bladders of the present invention and the liquid regulatory valves of the bladders. That is, the bladders herein may have devices that control the liquid flow into the garment. Additionally, devices such as flow meters may be incorporated into the hydration system that are designed to monitor flow in order to provide a constant saturation level of the cooling material. There may also be indicators incorporated in or on the garment to indicate to the wearer a particular saturation level of the cooling material. See U.S. Pat. Nos. 5,894,955; 6,212,959; and 6,070,767; all of which are incorporated herein by reference, as example of liquid regulatory valves of the present invention.

In other embodiments of the present invention, the bladder may provide the wearer with a source of bodily hydration. These embodiment include those where a tube feeding the hydrate into the cooling garment may be removed from the garment and inserted into the mouth. Alternatively, a second tube may be provided with the bladder.

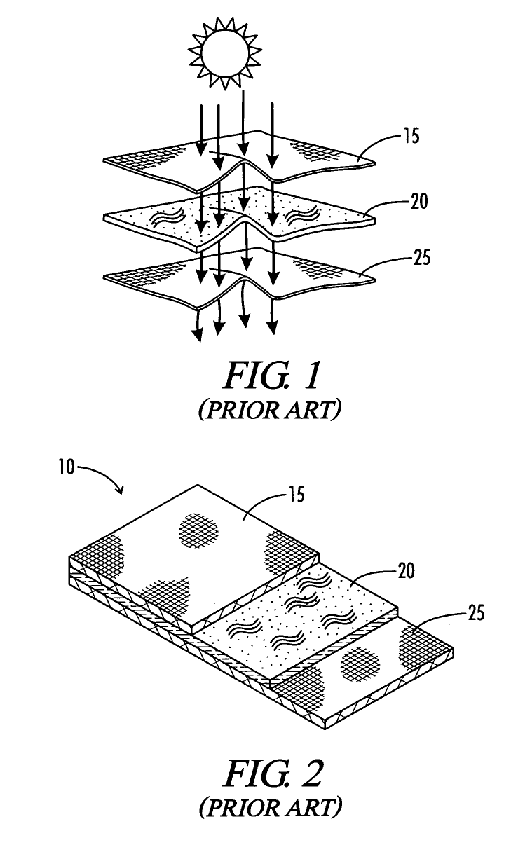

Now turning to the Figures, which are presented as an example of the present invention and should not be construed as being limiting thereof. FIGS. 1 and 2 demonstrates how embodiment of the cooling material 10 of the present invention operate. The material of these figures may be the material disclosed in U.S. Pat. No. 6,371,977, incorporated herein by reference. In this embodiment, the conductive layer 25 is the layer closes to the wearer. The retainer layer 15 helps sandwich the filler layer 20. The filler layer comprises the superabsorbent material.

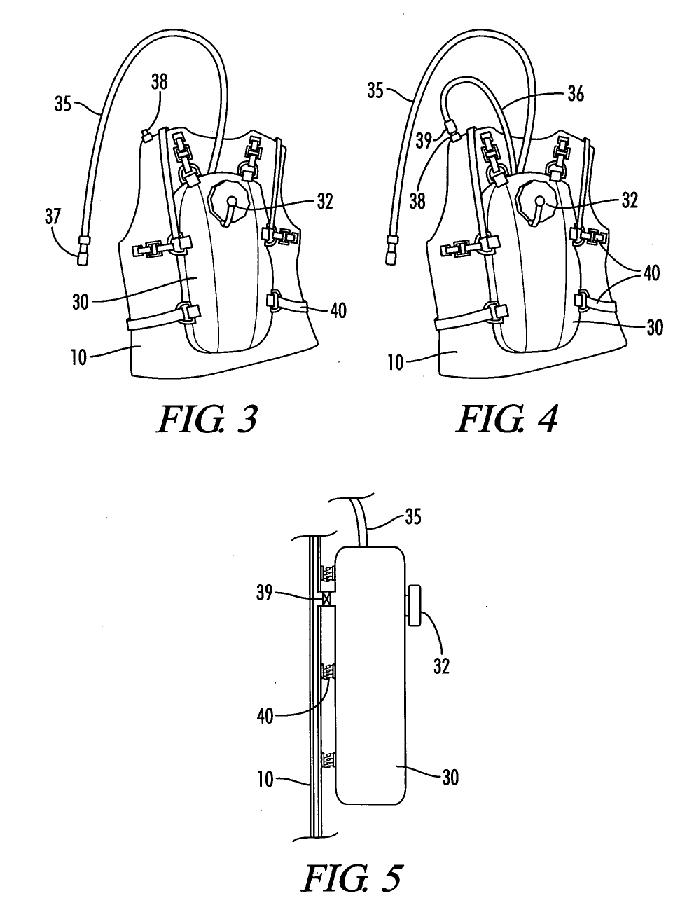

FIGS. 3 and 4 show an embodiment wherein the cooling material 10 is in the form of a vest. The bladder 30 is shown attached to the vest with a harness-type attachment system 40. The harness system is, of course, not critical and can be varies in many ways, ranging from back pack-type straps that allow the bladder to be completely and easily removable to a more permanent attachment mechanism. This bladder is equipped with a filler spout 32, which allows the bladder to be re-filled when desired. In FIG. 3, the bladder 30 hydrates the cooling material 10 by the use of a liquid delivery tube 35. This tube 35 allows a wearer to drink the hydrate in the bladder, or hydrate the vest by connecting the tube to an input port 38. This tube is further equipped with a liquid regulatory valve 37 which controls the flow of the liquid. FIG. 4 shows an embodiment with a second tube 36 directly hydrating the cooling composite material through a second fluid flow control valve 39. FIG. 4 shows an embodiment where the bladder 30 is directly attached to the composite material 10 by a fluid control valve 39.

Various patents and/or publications have been cited in this disclosure. All such patents and publication are expressly incorporated by reference in their entirety and, as such, should be regarded as being part of this disclosure.

The invention being described in the Specification and Drawings, it will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the Figures be considered as exemplary only, and not intended to limit the scope and spirit of the invention.

We claim:

1. A method of cooling a mammal by evaporation, comprising:
providing a multi-layered, liquid-retaining composite material comprising at least one of hydrophilic polymeric fibers or hydrophilic polymeric particles that that absorb at least about 2.5 times the fiber's or particle's weight in water;
providing a bladder that stores a liquid;
hydrating said multi-layered composite with a liquid; and
employing said multi-layered, liquid-retaining composite material as a garment or a flat sheet and evaporatively cooling said mammal;
wherein the bladder houses a liquid used to maintain or provide a state of hydration for at least part of the composite.

2. The method of claim 1, wherein the liquid-retaining composite material comprises a fiberfill batting material.

3. The method of claim 1, wherein the liquid-retaining composite material comprises hydrophilic polymeric fibers that absorb at least 2.5 times the fiber's weight in water.

4. The method of claim 1, wherein the composite material is a garment.

5. The method of claim 4, wherein the garment is a shirt, vest, pant, jacket, headband, hat, blanket or neckband.

6. The method of claim 1, wherein said hydrating step comprises soaking the composite material from 2-5 minutes.

7. The method of claim 1, wherein said fibers are composed of not less than about 90 weight percent of acrylontrile and less than about 10 weight percent of a water-absorbing resin containing carboxyl groups.

8. The method of claim 2, wherein said hydrophilic polymeric fibers are blended with said fiberfill in a range of from about 15 percent to about 75 percent with the fiberfill.

9. The method of claim 2, wherein said hydrophilic polymeric fibers are capable of expanding about 100 to about 300 times from their original dry size to a wet size responsive to the hydrating step.

10. The method of claim 1, wherein the fiberfill batting material comprises at least one of a woven aramid fiber or a polybenzamidazole fiber.

11. The method of claim 1, wherein the bladder is attachable to the composite material via a harness system.

12. The method of claim 1, wherein the bladder is attachable to the composite material via a hook and loop connection.

13. The method of claim 1, wherein the bladder is incorporated into the composite material.

14. The method of claim 1, wherein the bladder has a liquid flow tube attachable to the composite material to allow a liquid to flow from the bladder into the composite material.

15. A liquid-retaining, evaporative cooling device, comprising:
a multi-layered, liquid-retaining composite material that has at least one of hydrophilic polymeric fibers or hydrophilic polymeric particles that that absorb at least about 2.5 times the fiber's or particle's weight in water;
wherein said device comprises a bladder to hold a liquid and maintain or provide a state of hydration for at least part of the composite material.

16. The liquid-retaining, evaporative device of claim 15, wherein said composite material comprises a retainer layer, filler layer, and conductive layer, with:
the retainer layer and the conductive layer both communicating with the filler layer, and
the filler later including said at least one of hydrophilic polymeric fibers or hydrophilic polymeric particles that that absorb at least about 2.5 times the fiber's or particle's weight in water.

17. The liquid-retaining, evaporative device of claim 15, wherein the liquid-retaining composite comprises a fiberfill batting material.

18. The liquid-retaining, evaporative device of claim 15, wherein the liquid-retaining composite comprises hydrophilic polymeric fibers that that are composed of not less than about 90 weight percent of acrylontrile and less than about 10 weight percent of a water-absorbing resin containing carboxyl groups.

19. The liquid-retaining, evaporative device of claim 15, wherein the liquid-retaining composite material is a garment.

20. The liquid-retaining, evaporative device of claim 19, wherein the garment is a shirt, vest, pant, jacket, headband, hat, blanket or neckband.

21. The liquid-retaining, evaporative device of claim 15, wherein at least one of the fibers or particles are blended with a fiberfill batting material in a range of from about 15 percent to about 75 percent with the fiberfill batting material.

22. The liquid-retaining, evaporative device of claim 15, wherein the fiberfill batting material comprises at least one of a woven aramid fiber or a polybenzamidazole fiber.

23. The liquid-retaining, evaporative device of claim 15, wherein the fiberfill batting material comprises natural fibers.

24. The liquid-retaining, evaporative device of claim 15, wherein said hydrophilic fibers have diameters ranging from about 10 to about 50 microns and lengths ranging from about 3 to about 60 millimeters.

25. The liquid-retaining, evaporative device of claim 15, wherein the hydrophilic polymeric fibers are comprised of absorbent gelling material and said fibers are bi-component fibers.

26. The liquid-retaining, evaporative device of claim 15, wherein said bladder is attached to the composite material via a liquid delivery tube.

27. The liquid-retaining, evaporative device of claim 26, wherein the liquid-retaining composite material comprises an input port to receive said liquid delivery tube.

28. The liquid-retaining, evaporative device of claim 15, wherein said bladder comprises an output port, and the composite material comprises an input port, and the bladder is attached to the composite material via communication of the input and output ports.

29. The liquid-retaining, evaporative cooling device of claim 15, wherein the bladder comprises a harness to attach the bladder to the composite material.

30. The liquid-retaining, evaporative cooling device of claim 15, wherein the bladder is attached to the composite material via a hoop and loop connection.

31. The liquid-retaining, evaporative cooling device of claim 15, wherein the bladder is incorporated into the composite material.

32. A multi-layered evaporative cooling device, comprising:
a retainer layer,
a filler layer that comprises superabsorbent polymeric fibers, and
a conductive layer, wherein the retainer and conductive layers communicate with the filler layer; and
a bladder for holding liquid, with the bladder communicating with and hydrating at least a portion of the filler layer.

33. The multi-layered evaporative cooling device of claim 32, wherein the retainer, filler, and conductive layers are in the form of a garment.
